(19) United States
(12) Patent Application Publication
(10) Pub. No.: US 2026/0062967 A1
(43) Pub. Date: Mar. 5, 2026

(54) SYSTEMS AND METHODS FOR STAGED RETENTION OF A VEHICLE DOOR HANDLE

(71) Applicant: Huf Hülsbeck & Fürst GmbH & Co. KG, Velbert (DE)

(72) Inventors: Jeff Hansen, Farmington Hills, MI (US); Ayushi Srivastava, Farmington Hills, MI (US)

(21) Appl. No.: 18/824,980

(22) Filed: Sep. 5, 2024

(51) Int. Cl. E05B 85/10

(52) U.S. Cl. CPC E05B 85/107; E05B 85/103

(57) ABSTRACT

A system includes a bracket secured to a door panel of a vehicle, a counterweight pivotally attached to the bracket, a handle pivotally attached to the counterweight, the handle operable between a recessed position flush with the door panel and a deployed position extending away from the door panel, and a retention system including a retainer and a slider, the slider operable between an unsecured position and a secured position, and the handle being prevented from disengaging from the counterweight when the slider is in the secured position.

### FIELD

The present disclosure relates generally to vehicle door handles.

### BACKGROUND

This section provides background information related to the present disclosure which is not necessarily prior art.

During installation of an exterior handle to a handle assembly of a vehicle door, oftentimes a screw must be driven to rotate a counterweight to a position whereby the handle may be installed to the handle assembly. Because this process lacks intuitive design and operation, it can sometimes lead to user error during installation of the handle to the handle assembly. Accordingly, there is room for improvement in the field for a more user-friendly and efficient system for installing an exterior handle to a handle assembly of a vehicle door.

### SUMMARY

This section provides a general summary of the disclosure, and is not a comprehensive disclosure of its full scope or all of its features.

One aspect of the disclosure provides a system comprising a bracket secured to a door panel of a vehicle, a counterweight pivotally attached to the bracket, a handle pivotally attached to the counterweight, the handle operable between a recessed position flush with the door panel and a deployed position extending away from the door panel, and a retention system including a retainer and a slider, the slider operable between an unsecured position and a secured position, and the handle being prevented from disengaging from the counterweight when the slider is in the secured position.

Implementations of the disclosure may include one or more of the following optional features. In some implementations the handle is able to disengage from the counterweight when the slider is in the unsecured position.

The retainer may include a track. The slider may slide along the track. The track may have a T-shaped cross section and the slider may have a T-shaped slot, the T-shaped track receiving the slider via the T-shaped slot. The track may include a lower catch that engages with a portion of the slider to prevent the slider from disengaging from the track. The track may include an upper catch that engages with a portion of the slider to secure the slider in the secured position and prevent the slider from moving from the secured position to the unsecured position.

Another aspect of the disclosure provides a handle assembly for a door of a vehicle comprising a bracket secured to the door, a counterweight pivotally attached to the bracket, a handle pivotally attached to the counterweight, the handle operable between a recessed position flush with the door and a deployed position extending away from the door whereby the handle facilitates opening of the door to permit a user to access an interior of the vehicle, and a retention system including a retainer and a slider, the slider operable between an unsecured position and a secured position, and the handle being prevented from disengaging from the counterweight when the slider is in the secured position.

Implementations of the disclosure may include one or more of the following optional features. In some implementations the handle is able to disengage from the counterweight when the slider is in the unsecured position.

The retainer may include a track. The slider may slide along the track. The track may have a T-shaped cross section and the slider may have a T-shaped slot, the T-shaped track receiving the slider via the T-shaped slot. The track may include a lower catch that engages with a portion of the slider to prevent the slider from disengaging from the track. The track may include an upper catch that engages with a portion of the slider to secure the slider in the secured position and prevent the slider from moving from the secured position to the unsecured position.

Another aspect of the disclosure provides a method for securing a handle to a handle assembly, the method comprising securing a bracket to a door panel of a vehicle, pivotally attaching a counterweight to the bracket, securing a retention system to the bracket, the retention system including a retainer and a slider operable between an unsecured position and a secured position relative to the retainer, moving the slider to the unsecured position, pivotally attaching a handle to the counterweight, the handle operable between a recessed position flush with the door panel and a deployed position extending away from the door panel, and moving the slider to the secured position to secure the handle to the counterweight.

Implementations of the disclosure may include one or more of the following optional features. In some implementations the handle is able to disengage from the counterweight when the slider is in the unsecured position.

The retainer may include a track. The slider may slide along the track. The track may have a T-shaped cross section and the slider may have a T-shaped slot, the T-shaped track receiving the slider via the T-shaped slot.

The track may include an upper catch that engages with a portion of the slider to secure the slider in the secured position and prevent the slider from moving from the secured position to the unsecured position.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected configurations and not all possible implementations, and are not intended to limit the scope of the present disclosure.

FIG. 1 is a top elevation view of a portion of a handle assembly of a vehicle door;

FIG. 2 is a perspective view of a portion of the handle assembly of FIG. 1, with a handle installed;

FIG. 3A is a perspective view of a retention system of the handle assembly of FIG. 1 in an unsecured position;

FIG. 3B is a perspective view of the retention system of FIG. 3A in a secured position;

FIG. 4 is a top elevation view of a portion of the handle assembly of FIG. 1, with the retention system in the unsecured position and the handle in a first installation position;

FIG. 5 is a top elevation view of a portion of the handle assembly of FIG. 1, with the retention system in the secured position and the handle in a second installation position;

FIG. 6 is a top elevation view of a portion of the handle assembly of FIG. 1, with the retention system in the secured position and the handle in a third installation position; and

FIG. 7 is a top elevation view of a portion of the handle assembly of FIG. 1, with the retention system in the secured position and the handle in a fourth installation position.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

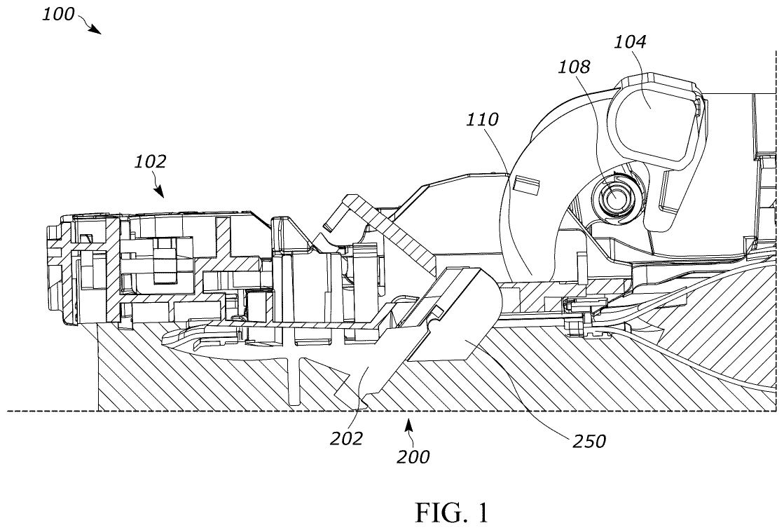

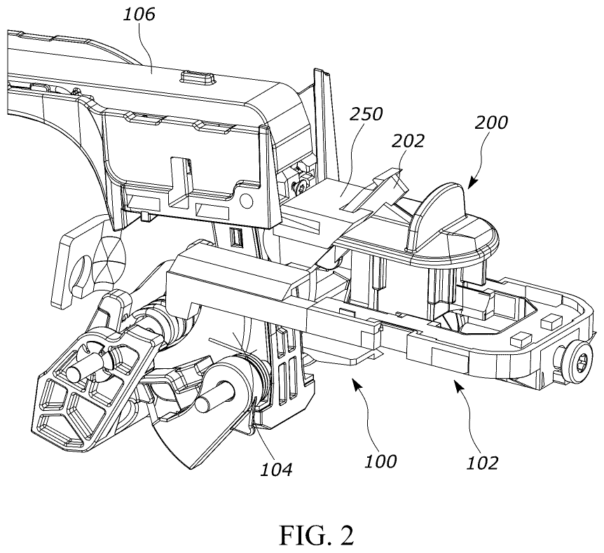

Referring to FIGS. 1 and 2, a handle assembly 100 is generally shown. The handle assembly 100 may generally be installed into a door panel of a vehicle, which may be an automobile or any other suitable vehicle. The handle assembly 100 includes a bracket 102 secured to the door panel and configured to receive a retention system 200. The handle assembly 100 includes a counterweight 104 configured to receive a handle 106. The handle assembly 100 may be designed to allow for improved efficiency in installing the handle 106 to the handle assembly 100, as will be described in greater detail.

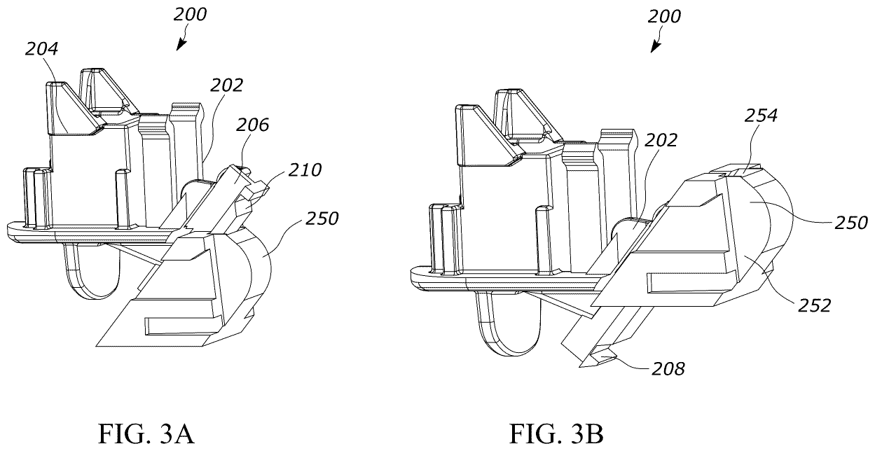

Referring to FIGS. 3A and 3B, the retention system 200 includes a retainer 202 and a slider 250. The retainer 202 includes a body portion 204 that is configured to attach to the bracket 102 of the handle assembly 100. In some implementations, the body portion 204 may be secured via snap interfaces, fasteners, adhesive, and/or any other suitable securement means. The retainer 202 includes a track 206 adjacent the body portion 204. The track 206 may include a generally T-shaped cross-section that engages with a corresponding T-shaped slot 254 of the slider 250. The track 206 includes a lower catch 208 that engages with an internal catch of the slider 250 to retain the slider 250 in an unsecured position, as shown in FIG. 3A. That is, the lower catch 208 prevents the slider 250 from falling off the track 206 in a generally downward direction per the perspective shown in FIG. 3A. The track 206 includes an upper catch 210 that engages with the internal catch of the slider 250 to retain the slider 250 in a secured position, as shown in FIG. 3B. That is, the engagement of the upper catch 210 with the internal catch prevents the slider 250 from moving along the track 206 toward the unsecured position.

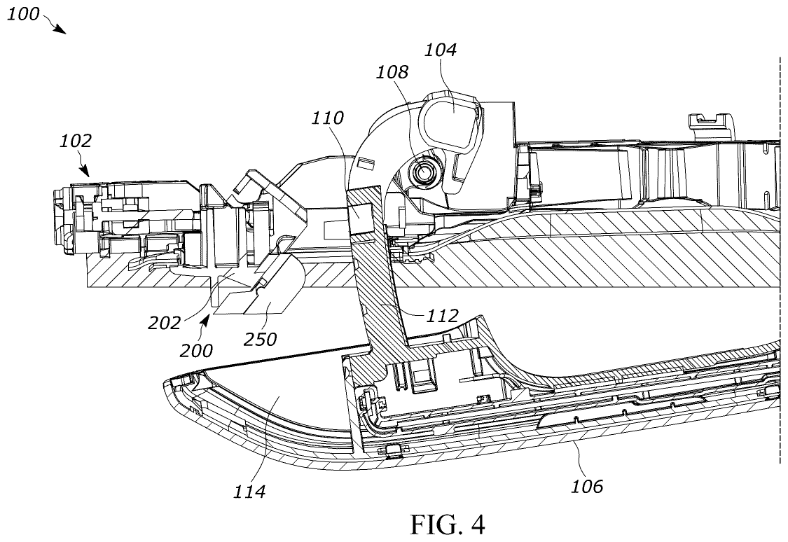

Referring to FIGS. 1 and 4, the counterweight 104 is pivotally attached to the bracket 102 and rotates about an axis 108 and includes an attachment point 110 for pivotally attaching to an arm 112 of the handle 106. The axis 108 and the attachment point 110 may each be defined by a pin, protrusion, or any other suitable member that facilitates rotation. The counterweight 104 rotates about the axis 108 to permit the handle 106 to move between the positions described below and shown in FIGS. 4-7.

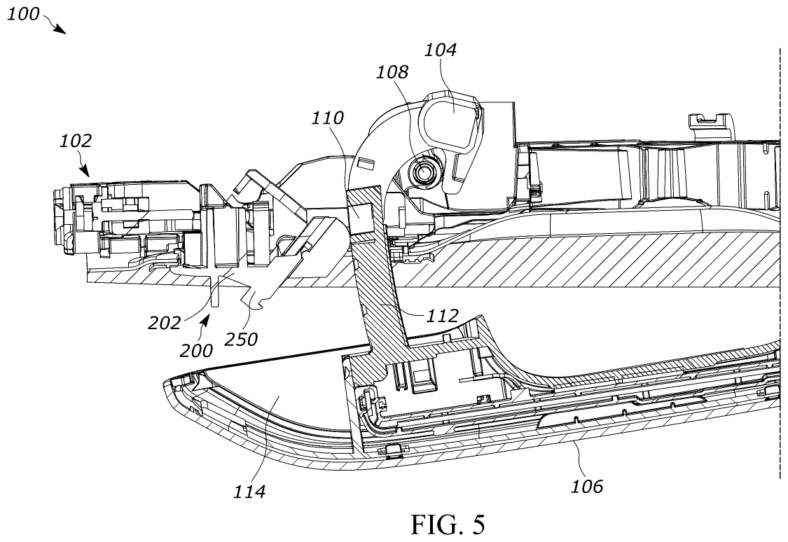

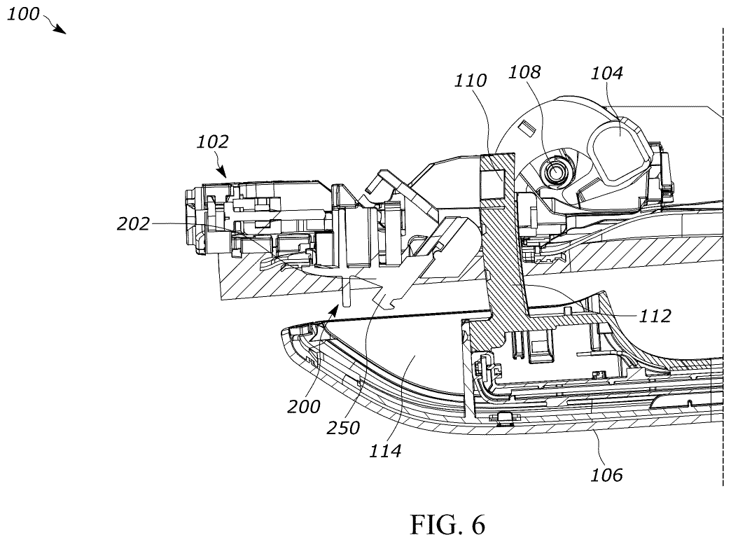

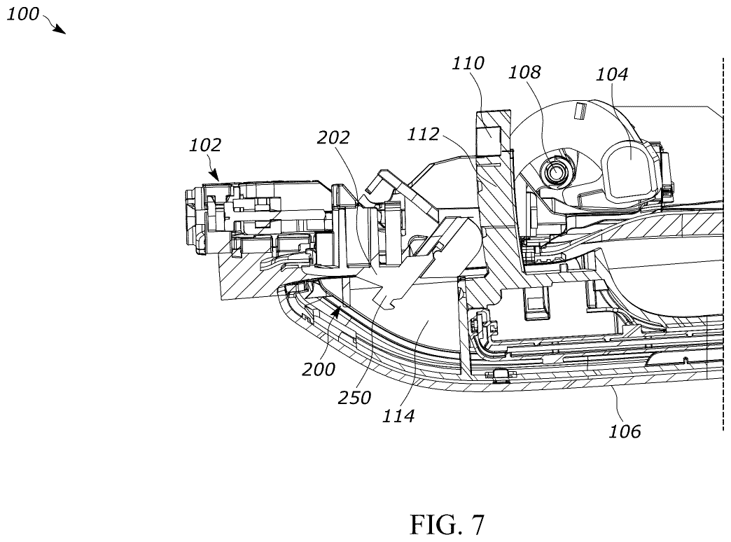

With reference to FIG. 4, the handle 106 includes the arm 112 that extends into the handle assembly 100 and attaches with the attachment point 110 of the counterweight 104. The handle 106 may include a cavity 114 that receives the retention system 200 when the handle 106 is secured to the handle assembly 100, as shown in FIG. 7. The handle 106 may move between a first, unsecured position (FIG. 4), a second, mid-installation position (FIG. 5), a third, secured and deployed position (FIG. 6), and fourth, secured and recessed or undeployed position (FIG. 7). In the deployed position, the handle 106 may extend away from the door panel such that a user may grasp the handle 106 and pull the handle 106 to open the door and access the interior of the vehicle. In the recessed position, the exterior surface of the handle 106 may be generally flush with the exterior surface of the door panel.

To install the handle 106 to the handle assembly 100, the slider 250 is slid to the unsecured position and the arm 112 of the handle 106 is pivotally attached to the counterweight 104 at the attachment point 110, as shown in FIG. 4. Referring to FIG. 5, the slider 250 is slid to the secured position (i.e., when the upper catch 210 engages with the internal catch of the slider 250). In the secured position, the slider 250 prevents the handle 106 (i.e., via the arm 112 of the handle 112 abutting the slider 250) from disengaging from the counterweight 104. Referring to FIG. 6, the handle 106 is moved to the secured, deployed position where the handle 106 is secured to the handle assembly 100 and can be grasped by a user to open the door. Referring to FIG. 7, the handle is moved to the secured, recessed position where the handle 106 is secured to the handle assembly 100 and the exterior surface of the handle 106 is generally flush with the exterior surface of the door panel.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed above could be termed a second element, component, region, layer or section without departing from the teachings of the example configurations.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A system comprising:
a bracket secured to a door panel of a vehicle;
a counterweight pivotally attached to the bracket;
a handle pivotally attached to the counterweight, the handle operable between a recessed position flush with the door panel and a deployed position extending away from the door panel; and
a retention system including a retainer and a slider, the slider operable between an unsecured position and a secured position, and the handle being prevented from disengaging from the counterweight when the slider is in the secured position.

2. The system of claim 1, wherein the handle is able to disengage from the counterweight when the slider is in the unsecured position.

3. The system of claim 1, wherein the retainer includes a track.

4. The system of claim 3, wherein the slider slides along the track.

5. The system of claim 4, wherein the track has a T-shaped cross section and the slider has a T-shaped slot, the T-shaped track receiving the slider via the T-shaped slot.

6. The system of claim 5, wherein the track includes a lower catch that engages with a portion of the slider to prevent the slider from disengaging from the track.

7. The system of claim 6, wherein the track includes an upper catch that engages with a portion of the slider to secure the slider in the secured position and prevent the slider from moving from the secured position to the unsecured position.

8. A handle assembly for a door of a vehicle comprising:
a bracket secured to the door;
a counterweight pivotally attached to the bracket;
a handle pivotally attached to the counterweight, the handle operable between a recessed position flush with the door and a deployed position extending away from the door whereby the handle facilitates opening of the door to permit a user to access an interior of the vehicle; and
a retention system including a retainer and a slider, the slider operable between an unsecured position and a secured position, and the handle being prevented from disengaging from the counterweight when the slider is in the secured position.

9. The handle assembly of claim 8, wherein the handle is able to disengage from the counterweight when the slider is in the unsecured position.

10. The handle assembly of claim 8, wherein the retainer includes a track.

11. The handle assembly of claim 10, wherein the slider slides along the track.

12. The handle assembly of claim 11, wherein the track has a T-shaped cross section and the slider has a T-shaped slot, the T-shaped track receiving the slider via the T-shaped slot.

13. The handle assembly of claim 12, wherein the track includes a lower catch that engages with a portion of the slider to prevent the slider from disengaging from the track.

14. The handle assembly of claim 13, wherein the track includes an upper catch that engages with a portion of the slider to secure the slider in the secured position and prevent the slider from moving from the secured position to the unsecured position.

15. A method for securing a handle to a handle assembly, the method comprising:
securing a bracket to a door panel of a vehicle;
pivotally attaching a counterweight to the bracket;
securing a retention system to the bracket, the retention system including a retainer and a slider operable between an unsecured position and a secured position relative to the retainer;
moving the slider to the unsecured position;
pivotally attaching a handle to the counterweight, the handle operable between a recessed position flush with the door panel and a deployed position extending away from the door panel; and
moving the slider to the secured position to secure the handle to the counterweight.

16. The method of claim 15, wherein the handle is able to disengage from the counterweight when the slider is in the unsecured position.

17. The method of claim 15, wherein the retainer includes a track.

18. The method of claim 17, wherein the slider slides along the track.

19. The method of claim 18, wherein the track has a T-shaped cross section and the slider has a T-shaped slot, the T-shaped track receiving the slider via the T-shaped slot.

20. The method of claim 15, wherein the track includes an upper catch that engages with a portion of the slider to secure the slider in the secured position and prevent the slider from moving from the secured position to the unsecured position.
